(19) United States
(12) Patent Application Publication
(10) Pub. No.: US 2016/0191650 A1
(43) Pub. Date: Jun. 30, 2016

(54) METHOD AND SYSTEM FOR DYNAMIC CONTENT PRE-CACHING

(71) Applicant: Yahoo Inc., Sunnyvale, CA (US)

(72) Inventors: Li Rong, Beijing (CN); Gaonan Zhang, Beijing (CN)

(21) Appl. No.: 14/368,890

(22) PCT Filed: Jun. 6, 2013
(86) PCT No.: PCT/CN2013/000676

§ 371 Date: Jun. 26, 2014

(51) Int. Cl. H04L 29/08

(52) U.S. Cl. CPC H04L 67/2847; H04L 67/306

(57) ABSTRACT

Method, system, and programs for dynamic content pre-caching. In one example, a first piece of information representing usage data of a user deice is obtained. A second piece of information representing a connection condition of the user device is also obtained. A third piece of information representing a pre-caching instruction is then received from a remote device. The third piece of information is generated based on the first and second pieces of information. One or more pieces of content are then fetched from a remote content source based on the third piece of information.

### BACKGROUND

1. Technical Field

The present teaching relates to methods, systems, and programming for Internet service. Particularly the present teaching relates to methods, systems, and programming for pre-caching online content.

2. Discussion of Technical Background

Personalized content recommendation systems are a subclass of information filtering systems that predict an “interest” that a user would have in online content such as articles, news, music, books, or movies), using a model built based on the characteristics of users and the content related thereto and the user's online behaviors. Personalized content recommendation systems have been used for providing dynamic web pages to users, which are web pages with online content that varies based on parameters provided by the users, i.e., the users' online behaviors and/or personal profiles, or a computer program.

One problem that often occurs when providing personalized dynamic online content to the users is the network accessibility, such as availability, stability and bandwidth, in particular, mobile device users frequently experience interrupted mobile usage during accessibility of wireless network, such as commuting, in a subway, taking elevators, or switching between different connection types, e.g., from Wi-Fi connection to 3G network. The frequent service interruption caused by poor network conditions will certainly affect user experience with dynamic content recommendation services.

Some known products use pre-caching techniques to relieve the adverse effect of connection interruption. Pre-caching refers to downloading data ahead of time in anticipation of its use, For example, when a web page is retrieved, the pages that users typically jump to when they leave that page might be pre-cached in anticipation. An application might pre-cache files that are commonly called for at some time during a session. However, pre-caching has to be manually initiated by users in known products. That is, users have to set up the parameters for pre-caching by themselves, which cannot be dynamically adjusted in view of the actual connection condition and the real-time content usage and prediction that are changed over time Therefore, there is a need to provide an improved solution for dynamic content pre caching to solve the above-mentioned problems.

### SUMMARY

The present teaching relates to methods, systems, and programming for Internet service. Particularly, the present teaching relates to methods, systems, and programming for pre-caching online content.

In one example, a method, implemented on at least one machine each of which has at least one processor, storage, and a communication platform connected to is network for dynamic content pre-caching, is disclosed. A first piece of information representing usage data of a user device is obtained. A second piece of information representing, a connection condition of the user device is also obtained. A third piece of information representing a pre-caching instruction is then received from is remote device. The third piece of information is generated based on the first and second pieces of information, One or more pieces of content are then fetched from a remote content source based on the third piece of information.

In another example, a method, implemented on at least one machine each of which has at least one processor, storage, and a communication platform connected to a network for dynamic content pre-caching, is disclosed, a first piece of information representing usage data of it user device is received. A second piece of information representing a connection condition of the user device is also received. One or more pieces of content that a user using the user device is likely interested in are determined based on the first piece of information and a machine-learned model. A manner in which the one or more pieces of content is to be fetched is also determined based on the second piece of information. A third piece of information representing a pre-caching instruction is sent to the user device. The pre-caching instruction indicates the manner in which the one or more pieces of content is to be fetched by the user device.

In as different example, as system having at least one processor, storage, and a communication platform connected to a network for dynamic content pre-caching is disclosed. The system includes a usage data monitoring unit, a connection condition monitoring unit, is pre-caching control unit, and a content fetching unit, each of which is implemented on the processor. The usage data monitoring unit is configured to obtain a first piece of information representing usage data of a user device. The connection condition monitoring unit is configured to obtain a second piece of information representing a connection condition of the user device. The dynamic content pre-caching module is configured to receive a third piece of information representing a pre-caching instruction from a remote device. The third piece of information is generated based on the first and second pieces of information. The content fetching unit is configured to fetch one or more pieces of content from a remote content source based on the third piece of information.

Other concepts relate to software for dynamic content pre-caching. A software product, in accord with this concept, includes at least one machine-readable non-transitory medium and information carried by the medium. The information carried by the medium may be executable program code data regarding parameters in association with a request or operational parameters, such as information related to a user, a request, or it social group, etc.

In one example, a machine readable and non-transitory medium having information recorded thereon for dynamic content pre-caching, wherein the information, when read by the machine, causes the machine to perform a series of steps. A first piece of information representing usage data of a user device is obtained. A second piece of information representing a connection condition of the user device is also obtained. A third piece of information representing a pre-caching instruction is then received from a remote deice. The third piece of information is generated based on the first and second pieces of information. One or more pieces of content are then fetched from a remote content source based on the third piece of information.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is an exemplary functional block diagram of a system for dynamic content pre-caching, according to an embodiment of the present teaching;

FIG. 2 is an exemplary functional block diagram of a dynamic content pre-caching system residing, on a user device, according to an embodiment of the present teaching;

FIG. 3 is an exemplary functional block diagram of a dynamic content prediction system residing on a remote device, according to an embodiment of the present teaching;

FIG. 4 is a flowchart of an exemplary process for dynamic content pre-caching, according to an embodiment of the present teaching;

FIG. 5 is a flowchart of another exemplary process for dynamic content pre-caching, according to an embodiment of the present teaching;

FIGS. 6-7 depict exemplary embodiments of a networked environment in dynamic content pre-caching is applied, according to different embodiments of the present teaching;

FIG. 8 depicts a general mobile device architecture on which the present teaching can be implemented; and

FIG. 9 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of dynamic content pre-caching based on real-time network connection condition, the method and system as disclosed herein enable extended period of time to users on connected mobile usage without network access. For example, the method and system as disclosed herein may predict the user's possible mobile usage, e.g., content that the user is likely interested in, and dynamically adjust the pre-caching of the predicted content based on real-time collected connection condition. More predicted content may be downloaded in advance when the current network connection is in a good condition, while less predicted content or no predicted content may be pre-cached when the current network connection is in a bad condition. On one hand, the content prediction and recommendation may be performed by in-depth analysis of users' historical behaviors data, along with the situational usage of the mobile device. On the other hand, the pre-caching may be dynamically controlled based on real-time network condition.

Additional novel features will be set forth in part in the description which follows, and in part will become apparent to those skilled in the art upon examination of the following and the accompanying drawings or may he learned by production or operation of the examples. The novel features of the present teaching may be realized and attained by practice or use of various aspects of the methodologies, instrumentalities and combinations set forth in the detailed examples discussed below.

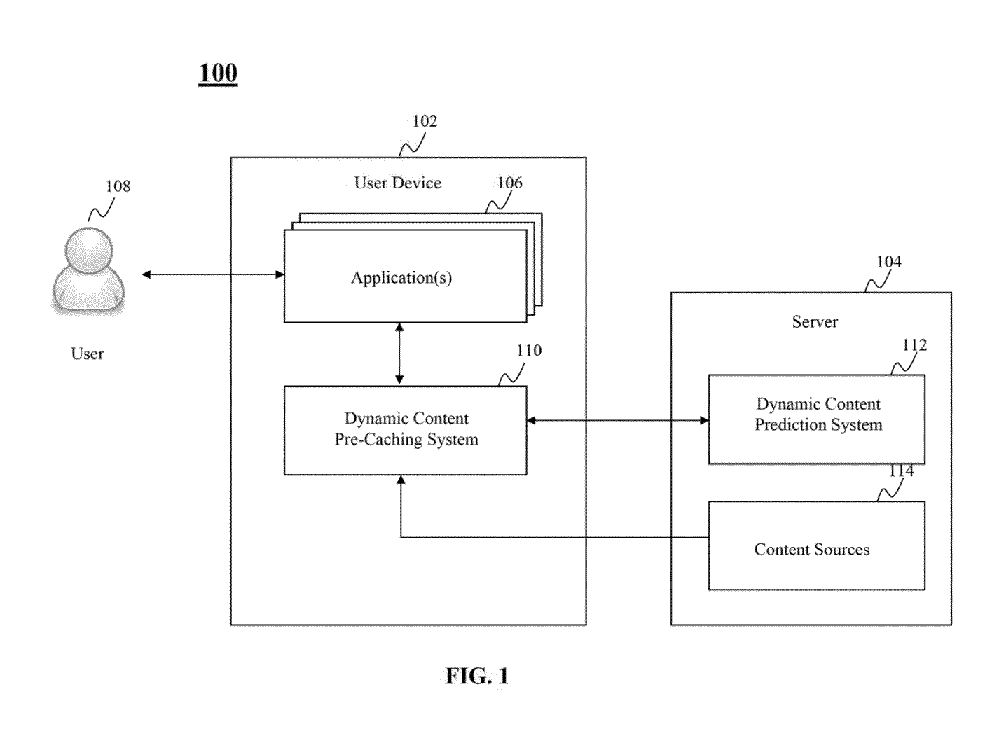

FIG. 1 is a high level exemplary system diagram of a system for dynamic content pre-caching, according to an embodiment of the present teaching. The system 100 in this example includes a user device 102 and a remote device, such as a server 104, communicating with each other through a network (not shown). The user device 102 may he a laptop computer, desktop computer, notebook computer, media center, mobile device, gaming console, set-top box, printer, or any other suitable device. In this example, the user device 102 includes a mobile device (handheld device or portable device), such as but not limited to, as smart phone, a tablet, a music player, a handheld gaming console, and a GPS. Various applications 106 may reside on the user device 102 to perform one or more tasks for a user 108 using the user device 102. The applications 106 may be any suitable applications pre-installed on the user device 102, such as a web browser, etc., or any third-party applications installed by the user 108, such as a social network client application, a news feeding application, etc. The user 108 in this example interacts with the applications 106 to complete one or more tasks, for example, composing and sending entails through an email client application, browsing web pages through a web browser, and updating social network account through a social network client application.

A dynamic content pre-caching system 110 also resides on the user device 102 in this example. The dynamic content pre-caching system 110 may be a stand-alone application installed on the user device 102 or as software library in the form of compiled binary that can be integrated with one of the applications 106 by third-party developers of the applications 106 on various mobile operating systems, e.g., iOS, Android, Windows Phone, etc. The library may include application programming interfaces (APIs) allowing developers of the applications 106 to configure user interfaces or any other functionalities and features of the dynamic content pre-caching system 110. In this example, the dynamic content pre-caching, system 110 may collect information including usage data and network connection condition from the applications 106, other components of the user device 102, and/or the user 108. The collected information may be sent to a dynamic content prediction system 112 on the server 104.

The dynamic content prediction system 112 may perform behavioral and situational analysis based on the received usage data using a machine-learned prediction model to predict content that the user 108 is likely interested in. The dynamic content prediction system 112 also generates pre-caching instructions by analyzing the real-time collected connection condition of the user device 102, which controls the manner in which the predicted dynamic content is pre-cached based on the current network connection condition. The pre-caching instructions are sent back to the dynamic content pre-caching system 110 on the user device 102. Based on the pre-caching instruction, the dynamic content pre-caching system 110 on the user device 102 dynamically adjusts the fetching of the predicted dynamic content from content sources 114 in a manner suitable for the current connection condition in order to achieve uninterrupted dynamic Content. streaming, The content that is dynamically pre-cached in a cache memory then may be rendered by an application 106 and presented to the use 108.

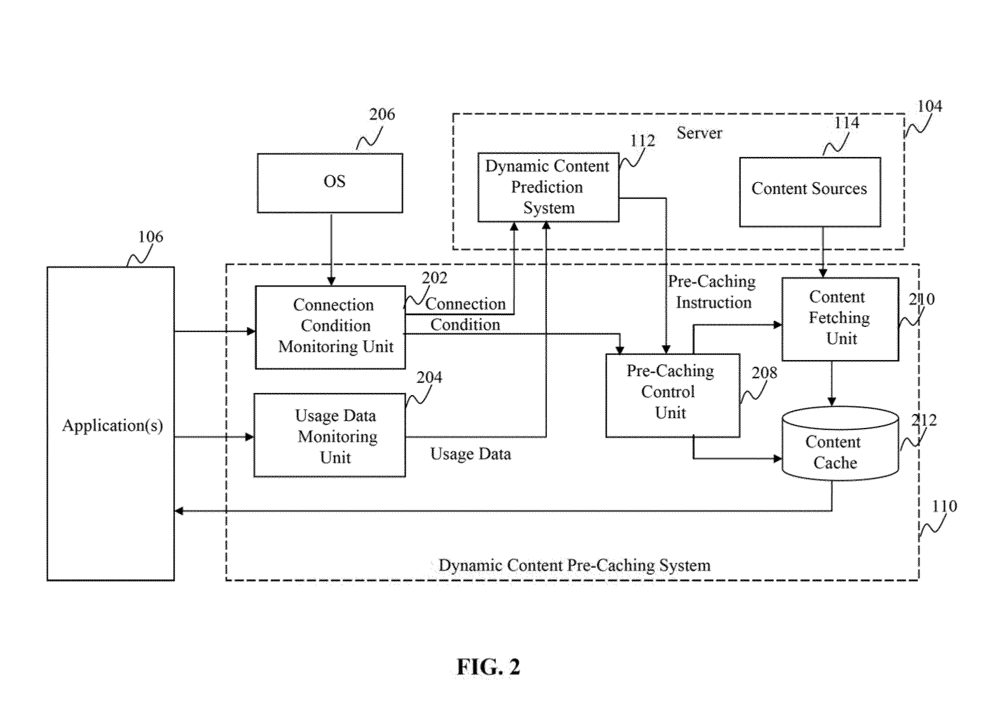

FIG. 2 is an exemplary functional block diagram of a dynamic content pre-caching system residing on a user device according to an embodiment of the present teaching. The dynamic content pre-caching system 110 in this example includes a connection condition monitoring unit 202 and a usage data monitoring unit 204. The connection condition monitoring unit 202 is configured to collect information related to connection conditions in real-time from various sources, such as, for example a third-party application 106 for network condition monitoring, the operating system 206, or any physical sensors (not shown) on the user device 102. The connection condition includes, for example, connection speed or available bandwidth, connection type. e.g., 2G, 3G, or 4G wireless network and Wi-Fi connection, and connection fee. The connection speed and/or connection type may affect the availability and stability of dynamic content recommendation services. For example, when the user device 102 is in an elevator or a subway, the dynamic content recommendation may be interrupted due to network failures, e.g., loss of wireless signals. The connection type and/or connection fee may be another factor for consideration in adjusting the pre-caching of dynamic content. For example, when the current wireless connection is a Wi-Fi connection or when the current connection is free of charge (e.g., due to promotion or during a special time period), it is desired to pre-cache more content to save cost. On the other hand, when a relative high connection fee is applied to the current connection, the pre-caching then may be limited or even stopped to reduce cost.

The usage data monitoring unit 204 in this example is configured to collect information related to usage data from the applications 106 and/or the user 108. The usage data may include information about the kinds of things that the user 108 is doing (e.g., browsing web pages, updating social network account status, uploading photos, etc.). That is, the usage data monitoring unit 204 may continuously monitor content that is being presented on the user device 102 (e.g., an article the user 108 is reading on the user device 102) and activities that are performed on the user device (e.g., forwarding an article to friends in the user's social network, or composing an email recommendation a movie to a friend). En addition, the usage. data. may also include the profile of the user 108, such as demographic information and explicit user interests, The usage data is a good source for user behavior analysis in personalized content prediction and recommendation. information related to the connection condition and usage data. is then sent to the dynamic content prediction system 112 in the remote server 104.

In this example, the dynamic content pre-caching system 110 also includes a pre-caching control unit 208 configured to dynamically adjust the fetching of predicted content in advance from the content sources 114 based on the pre-caching instruction received front the dynamic content prediction system 112. As will be described in detail later, the pre-caching instruction is generated based on the collected connection condition and usage data using behavioral and situational analysis. The pre-caching instruction indicates the predicted content that the user 108 is likely interested in and also the mariner in which the predicted content is pre-cached in view of the real-time connection condition. Based on the pre-caching instruction, the pre-caching control unit 208 dynamically controls a content fetching unit 210 to adjust the content fetching from the content sources 114. The fetched content may be temporarily stored in a content cache 212. For example, when the network connection is in a good condition, e.g., having strong wireless signals or a large bandwidth, or when the current connection fee is very low or even zero, the pre-caching control unit 208 may instruct the content fetching unit 210 to download a large size/volume of predicted content in advance and store all the predicted content in the content cache for future use. When the network connection is in a bad condition, e.g., having weak or no wireless signals or to limited bandwidth, or when the connection fee is high, the pre-caching control unit 208 may instruct the content fetching unit 210 to download only a small volume/size of predicted content or even stop the pre-caching at all. In this example, such adjustment may be performed in response to the change of connection condition in real-time.

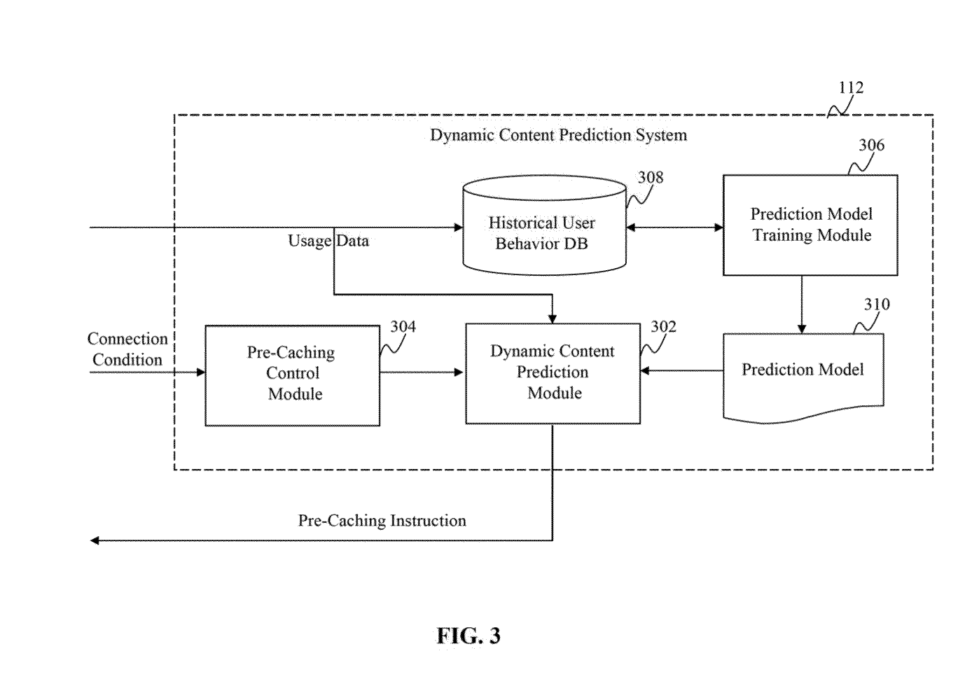

FIG. 3 is an exemplary functional block diagram of a dynamic content prediction system residing on a remote device, according to an embodiment of the present teaching. The dynamic content prediction system 112 in this example includes a dynamic content prediction module 302 a pre-caching control module 304, and a prediction model training module 306. The dynamic content prediction module 302 is configured to determine content that the user 108 is likely interested in based on the received usage data from the user device 102. In this example, the dynamic content prediction module 302 performs behavioral and situational analysis based on a machine-learned prediction model 310. The prediction model 310 may be optimized by the prediction model training module 306 based on historical user behavior data stored in a historical user behavior database 308 using any suitable known machine learning or data mining approaches. The historical user behavior data may be gathered from usage data of a number of users received from their user devices, in other words, user behaviors from a group of users have been modeled based on historical usage data and are used as a basis for predicting a specific user's future behavior based on the user's current behavior. Based on the real-time collected usage data from the user device 102, the dynamic Content prediction module 302 then may predict the user's future usage and recommend content for the user 108 accordingly.

In this example, the pre-caching control module 304 may adjust the manner in which the predicted content is fetched in advance based on the received connection condition. For example, a threshold of connection condition may be preset by the pre-caching control module 304 and used for determining an appropriate pre-caching instruction. For example, a preset connection speed may be a threshold for starting the pre-caching such that any detected connection speeds that are lower than the threshold may cause the pre-caching to he stopped. In one example, the pre-caching may be controlled by adjusting the duration of pre-caching, for example, continuously pre-caching in the next 30 seconds. In another example, the pre-caching may be controlled by adjusting the size/volume of content to be pre-cached, for example, pre-caching 10 MB of content in the current network condition. In still another example, the pre-caching may be controlled by adjusting the download speed, e.g., pre-caching at the speed of 100 KB/sec.

It is understood that, in other examples, the pre-caching control may not be performed at the remote server 104, but instead, by the user device 102 only. In those examples, the dynamic content prediction system 112 may only provide the predicted content to the user device 102 based on the received usage data, while the pre-caching control unit 208 on the user device 102 receives the connection condition directly from the connection condition monitoring unit 202 and controls the pre-caching of the predicted content accordingly.

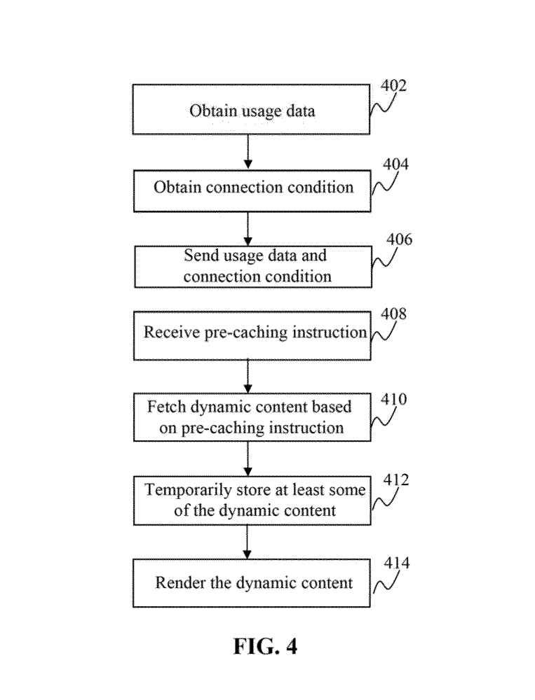

FIG. 4 is a flowchart of an exemplary process for dynamic content pre-caching, according to an embodiment of the present teaching. Starting from 402, a first piece of information representing usage data of a user device is obtained. The usage data may include content that is presented on the user device, an activity that is performed on the user device, and a profile of a user using the user device. In this example, the usage data is continuously gathered in real-time. At 404, a second piece of information representing a connection condition of the user device is obtained. The connection condition may include connection speed, connection type, and connection fee. In this example, the connection condition is continuously monitored in real-time. Moving to 406, the first piece of information representing the usage data and the second piece of information representing the connection condition are sent to a remote device, e.g., a server. At 408, a third piece of information representing a pre-caching instruction is received from the remote device. The pre-caching instruction may indicate a manner in which content that the user is likely interested in is fetched in advance. At 410, dynamic predicted content is then fetched in advance based on the pre-caching instruction. Moving to 412, at least some of the fetched content is temporarily stored in a content cache. At 414, the fetched content is rendered on the user device for the user.

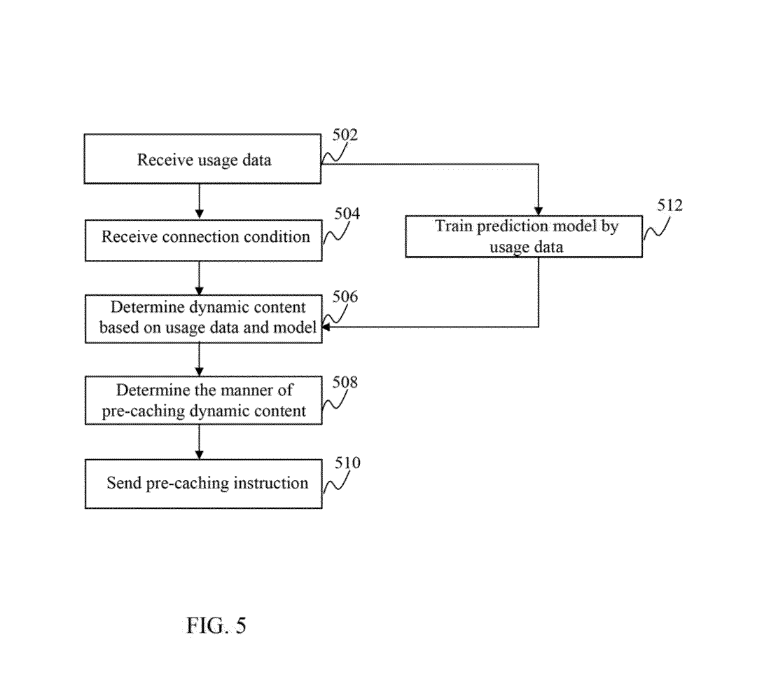

FIG. 5 is a flowchart of another exemplary process for dynamic content pre-caching, according to an embodiment of the present teaching. Starting from 502, a first piece of information representing usage data is received from a user device. At 504, a second piece of information representing a connection condition is received from the user device. Moving to 506, one or more pieces of content that a user using the user device is likely interested in (dynamic predicted content) is determined based on the usage data and a machine-learned model. The machine-learned model may be any suitable prediction model trained by historical user behaviors data using any suitable known machine learning or data mining approaches. At 508, a manner in which the one or more pieces of content (dynamic predicted content) are to be fetched in advance is determined based on the connection condition. At 510, a third piece of information representing a pre-caching instruction is sent back to the user device. The pre-caching instruction indicates the manner in which the dynamic predicted content to be fetched in advance by the user device. The machined-learned prediction model may be trained at 512 by continuously collected usage data from different user devices.

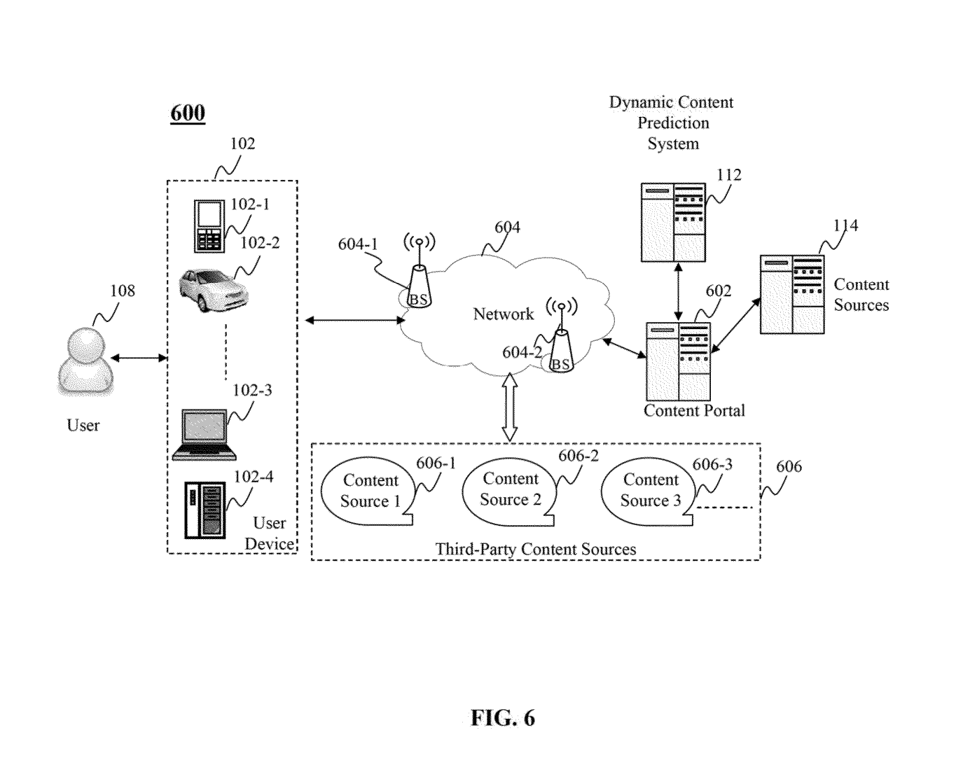

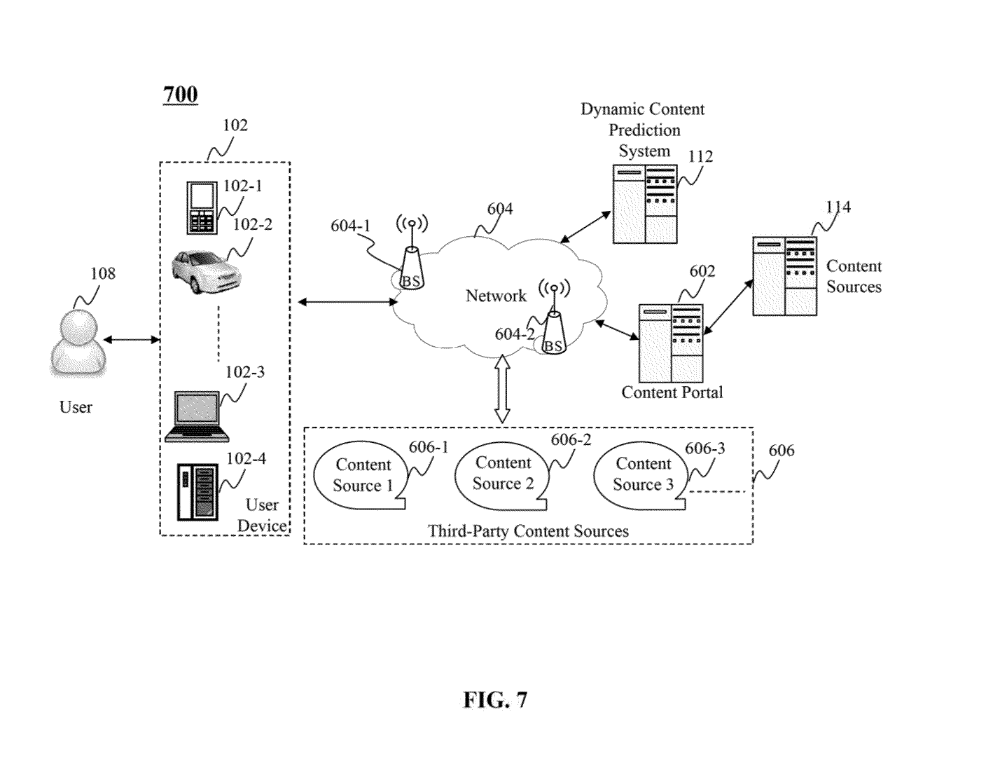

FIGS. 6-7 depict exemplary embodiments of a networked environment in which dynamic content pre-caching is applied, according. to different. embodiments of the present teaching. In FIG. 6, an exemplary networked environment 600 includes the dynamic content prediction system 112, the content sources 114, the users 108, the user devices 102, a content portal 602, a network 604, and third-party content sources 606. The network 604 may be a single network or a combination of different networks. For example, the network 604 may be a local area network (LAN), a wide area network (WAN), a public network, a private network, a proprietary network, a Public Telephone Switched Network (PSTN), the Internet, a wireless network, a virtual network, or any combination thereof. The network 604 may also include various network access points, e.g., wired or wireless access points such as base stations or Internet exchange points 604-1, . . . , 604-2, through which a data source may connect to the network 504 in order to transmit information via the network 604.

Users 108 may be of different types such as users connected to the network 604 via different user devices 102, for example, a desktop computer 102-4, a laptop computer 102-3, a mobile device 102-1, or a built-in device in a motor vehicle 102-2. A user 108 may use the user device 102 to send a request and provide basic user information to the content portal 602 (e.g., a search engine, a social media website, etc) via the network 604 and receive personalized content streams front the content portal 602 through the network 604. The dynamic content prediction system 112 in this example may work as backend support for the content portal 602 to predict and recommend dynamic content for the user 108. in this example, the content sources 114 may also serve as backend support to provide content for the content portal 602. In addition to the content sources 114 of the content portal 602, dynamic content may also be retrieved from third-party content sources 606-1, 606-2, 606-3, A third-party content source may correspond to a website hosted by an entity, whether an individual, a business, or an organization such as USPTO.gov, a content provider such as cnn.com and facebook.com, or a content feed source such as Twitter or blogs.

FIG. 7 presents a similarly networked environment as what is shown in FIG. 6 except that the dynamic content prediction system 112 is configured as an independent service provider that interacts with the users 108 directly to provide personalized content recommendation service. In the exemplary networked environment 700, the dynamic content prediction system 112 may receive a request with some basic information from a user 108 and provide personalized content streams to the user 108 directly without going through a third-party content portal 602.

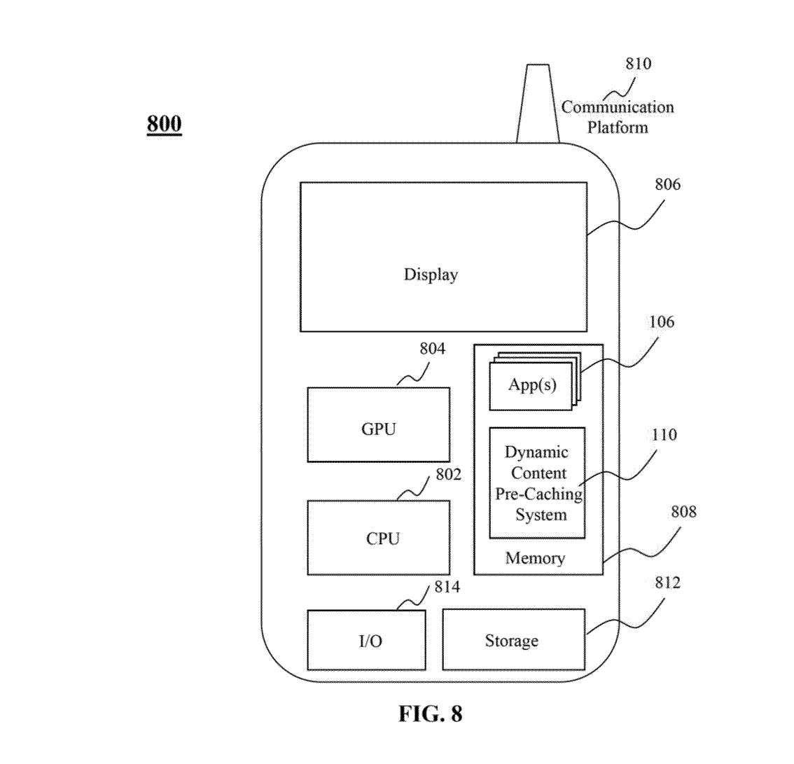

FIG. 8 depicts a general mobile device architecture on which the present teaching can be implemented. In this example, the user device on which dynamic content pre-caching is performed is a mobile device 800, including but is not limited to, a smart phone, a tablet, a music player, a handled gaming console, a global positioning system (GPS) receiver. The mobile device 800 in this example includes one or more central processing units (CPUs) 802, one or more graphic processing units (GPUs) 804, a display 806, a memory 808, a communication platform 810, such as a wireless communication module, storage 812, and one or more input/out-put (I/O) devices 814. Any other suitable component, such as but not limited to a system bus or a controller (not shown), may also be included in the mobile device 800. A mobile operating system (not shown), e.g., iOS, Android, Windows Phone, etc., one or more applications 106, and the dynamic content pre-caching system 110 may be loaded into the memory 808 from the storage 812 in order to be executed by the CPU 802. The applications 106 may include a browser or any other suitable mobile apps for receiving and rendering personalized content streams on the mobile device 800. Execution of the applications 106 and the dynamic content pre-caching system 110 may cause the mobile device 800 to perform the processing as described above, e.g., in FIG. 4, For example, the display of personalized content to the user ma be made by the. GPU 804 in conjunction with the display 806. The pre-caching of the predicted content may be performed by the memory 808 and/or storage 812. Usage data and connection condition may be collected via the 110 devices 814 and provided to the dynamic content prediction system 112 on the remote server via the communication platform 810

To implement the present teaching, computer hardware platforms may be used as the hardware platform(s) for one or more of the elements described herein. The hardware elements, operating. systems, and programming languages of such computers are conventional in nature, and it is presumed that those skilled in the art are adequately familiar therewith to adapt those technologies to implement the processing essentially as described herein. A computer with user interface elements may be used to implement as personal computer (PC) or other type of work station or terminal device, although a computer ma also act as a server if appropriately programmed. It is believed that those skilled in the art are familiar with the structure, programming, and general operation of such computer equipment and as a result the drawings should be self-explanatory.

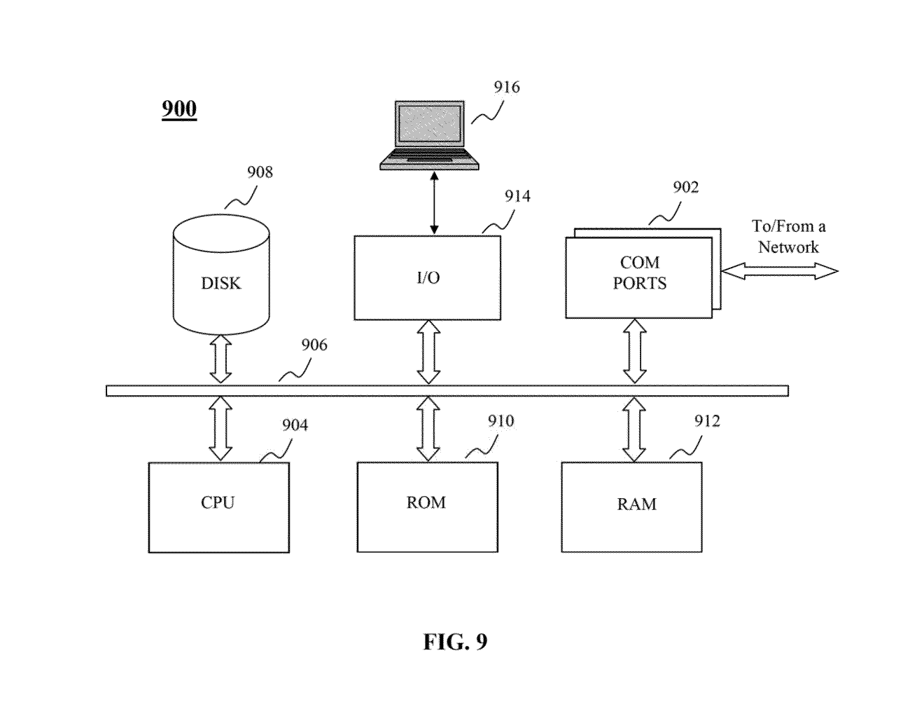

FIG. 9 depicts a general computer architecture on which the present teaching can be implemented and has it functional block diagram illustration of a computer hardware platform that includes user interface elements. The computer may be a general-purpose computer or a special purpose computer. This computer 900 can be used to implement any components of the dynamic content pre-caching architecture as described herein. Different components of the system in the present teaching can all be implemented on one or more computers such as computer 900, via its hardware, software program, firmware, or a combination thereof Although only one such computer is shown, for convenience, the computer functions relating to the dynamic content pre-caching may be implemented in a distributed fashion on a number of similar platforms, to distribute the processing load.

The computer 900, for example, includes COM ports 902 connected to and from a network connected thereto to facilitate data communications. The computer 900 also includes a central processing unit (CPU) 904, in the form of one or more processors, for executing program instructions, The exemplary computer platform includes an internal communication bus 906, program storage and data storage of different forms, e.g., disk 908, read only memory (ROM) 910, or random access memory (RAM) 912, for various data tiles to be processed and/or communicated by the computer, as well as possibly program instructions to be executed by the CPU. The computer 900 also includes an I/O component 914, supporting input/output flows between the computer and other components therein such as user interface elements 916. The computer 900 may also receive programming and data via network communications.

Hence, aspects of the method of dynamic content pre-caching, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to an medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example; a floppy disk, a flexible disk, hard disk, magnetic tape., any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Man of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution. In addition, the components of the system as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. it is intended by the following claims to claim any and all applications, modifications and variations that fail within the true scope of the present teachings.

We claim:

1. A method implemented on at least one machine, each of which has at least one processor, storage, and a communication platform connected to a network for dynamic content pre-caching, the method comprising the steps of:
obtaining a first piece of information representing usage data of a user device,
obtaining a second piece of information representing a connection condition of the user device;
receiving a third piece of information representing a pre-caching instruction from a remote device, wherein the third piece of information is generated based on the first and second pieces of information; and
fetching one or more pieces of content from a remote content source based on the third piece of information.

2. The method of claim 1, wherein the usage data includes at least one of:
content that is presented on the user device:
an activity that is performed on the user device; and
a profile of a user using the user device.

3. The method of claim 1, wherein the connection condition includes at least one of:
connection speed;
connection type; and
connection fee.

4. The method of claim 1, further comprising:
temporarily storing at least some of the fetched one or more pieces of content based on the third piece of information.

5. The method of claim 1, further comprising:
determining the one or more pieces of content that a user using the user device is likely interested in based on the first piece of information and a machine-learned model; and
determining a manner in which the one or more pieces of content is to be fetched based on the second piece of information.

6. The method of claim 5, wherein the machine-learned model is trained by continuously collecting the first piece of information from a plurality of user devices.

7. A system having at least one processor, storage, and a communication platform connected to a network for dynamic content pre-caching, the system comprising:
a usage data monitoring unit implemented on the processor and configured to obtain a first piece of information representing usage data of a user device;
a connection condition monitoring unit implemented on the processor and configured to obtain a second piece of information representing a connection condition of the user device;
a pre-caching control unit implemented on the processor and configured to receive a third piece of information representing a pre-caching instruction from a remote device, wherein the third piece of information is generated based on the first and second pieces of information; and
a content fetching unit implemented on the processor and configured to fetch one or more pieces of content from a remote content source based on the third piece of information.

8. The system of claim 7, wherein the usage data includes at least one of:
content that is presented on the user device;
an activity that is performed on the user device; and
a profile of a user using the user device.

9. The system of claim 7, wherein the connection condition includes at least one of:
connection speed;
connection type; and
connection fee.

10. The system of claim 7, further comprising:
a content cache configured to temporarily store at least some of the fetched one or more pieces of content based on the third piece of information.

11. A machine-readable tangible and non-transitory medium having information recorded thereon for dynamic content pre-caching, wherein the information, when read by the machine, causes the machine to perform the following:
obtaining a first piece of information representing usage data of a user device:
obtaining a second piece of information representing a connection condition of the user device;
receiving a third piece of information representing a pre-caching instruction from a remote device, wherein the third piece of information is generated based on the first and second pieces of information; and
fetching one or more pieces of content from a remote content source based on the third piece of information.

12. The medium of claim 11, wherein the usage data includes at least one of:
content that is presented on the user device;
an activity that is performed on the user device; and
a profile of a user using the user device.

13. The medium of claim 11, wherein the connection condition includes at least one of:
connection speed;
connection type; and
connection fee.

14. The medium of claim 11, further comprising:
temporarily storing at least some of the fetched one or more pieces of content based on the third piece of information.

15. The medium of claim 11, further comprising:
determining the one or more pieces of content that a user using the user device is likely interested in based on the first piece of information and a machine-learned model; and
determining a manner in which the one or more pieces of content is to be fetched used on the second piece of information.

16. The medium of claim 15, wherein the machine-learned model is trained by continuously collecting the first piece of information from a plurality of user devices.

17. A method implemented on at least one machine, each of which has at least one processor, storage, and a communication platform connected to a network for dynamic content pre-caching, the method comprising the steps of:
receiving a first piece of information representing usage data of a user device;
receiving a second piece of information representing a connection condition of the user device;
determining one or more pieces of content that a user using the user device is likely interested in based on the first piece of information and a machine-learned model; and
determining a manner in which the one or more pieces of content is to be fetched based on the second piece of information; and
sending a third piece of information representing a pre-caching instruction to the user device, wherein the pre-caching instruction indicates the manner in which the one or more pieces of content is to be fetched by the user device.

18. The method of claim 17, wherein the machine-learned model is trained by continuously collecting the first piece of information from a plurality of user devices.

19. The method of claim 17, wherein the usage data includes at least one of:
content that is presented on the user device;
an activity that is performed on the user device; and
a profile of a user using the user device.

20. The method of claim 17, wherein the connection condition includes at least one of:
connection speed;
connection type; and
connection fee.
